(19) United States
(12) Patent Application Publication
(10) Pub. No.: US 2026/0099154 A1
(43) Pub. Date: Apr. 9, 2026

(54) ROBOT AND CONTROL METHOD THEREOF

(71) Applicant: SAMSUNG ELECTRONICS CO., LTD., Suwon-si (KR)

(72) Inventors: Choongwon SEO, Suwon-si (KR); Boseok MOON, Suwon-si (KR); Jongmyeong KO, Suwon-si (KR); Muwoong LEE, Suwon-si (KR)

(73) Assignee: SAMSUNG ELECTRONICS CO., LTD., Suwon-si (KR)

(21) Appl. No.: 19/305,322

(22) Filed: Aug. 20, 2025

Related U.S. Application Data
(63) Continuation of application No. PCT/KR2025/008566, filed on Jun. 20, 2025.

(30) Foreign Application Priority Data
Oct. 8, 2024 (KR) 10-2024-0136988

(51) Int. Cl. G05D 1/648; A01K 15/02; A01K 29/00; A47L 7/00; A47L 9/28; G05D 105/10

(52) U.S. Cl. CPC G05D 1/6484; A01K 15/025; A47L 7/0085; A47L 9/2852; A47L 9/2894; A01K 15/0201; A01K 29/007; A47L 2201/04; G05D 2105/10

(57) ABSTRACT

Provided is a robot including: communication circuitry; a driver; memory storing instructions; and a processor, wherein the instructions, when executed by the processor, cause the robot to: based on cleaning being started, transmit, to at least one accessory device through the communication circuitry, a first signal notifying of a start of cleaning and requesting a pet search, based on receiving search information regarding a pet obtained from the at least one accessory device, transmit, to the at least one accessory device through the communication circuitry, a second signal notifying of a luring position of the pet based on a cleaning position and the search information, and based on receiving a third signal indicating the pet was successfully lured to the luring position, control the driver to move the robot to the cleaning position and control the robot to start cleaning at the cleaning position.

### CROSS-REFERENCE TO RELATED APPLICATIONS

This application is a bypass continuation of International Application No. PCT/KR2025/008566, filed on Jun. 20, 2025, which is based on and claims priority to Korean Patent Application No. 10-2024-0136988, filed on Oct. 8, 2024, in the Korean Intellectual Property Office, the disclosures of which are incorporated by reference herein in their entireties.

### BACKGROUND

### 1. Field

The disclosure relates to a robot and a control method thereof, and more particularly, to a robot that lures a pet and a control method thereof.

### 2. Description of Related Art

Recently, developments in technology with respect to robots that are disposed in a specific space and provide services to users have become active.

For example, a robot cleaner may be a smart device developed to automatize floor cleaning, and may absorb dust and foreign substances while moving on its own.

### SUMMARY

According to an aspect of the disclosure, a robot includes: communication circuitry; a driver; memory storing instructions; and at least one processor including processing circuitry, wherein the instructions, when executed by the at least one processor individually or collectively, cause the robot to: based on cleaning being started, transmit, to at least one accessory device through the communication circuitry, a first signal notifying of a start of cleaning and requesting a pet search, based on receiving search information regarding a pet obtained from the at least one accessory device, transmit, to the at least one accessory device through the communication circuitry, a second signal notifying of a luring position of the pet based on a cleaning position and the search information, and based on receiving a third signal indicating the pet was successfully lured to the luring position, control the driver to move the robot to the cleaning position and control the robot to start cleaning at the cleaning position.

The instructions, when executed by the at least one processor individually or collectively, may further cause the robot to: identify a first cleaning position, from among a plurality of cleaning positions, based on the search information, and the cleaning position may be the first cleaning position.

The instructions, when executed by the at least one processor individually or collectively, may further cause the robot to: identify a second cleaning position, from among a plurality of cleaning positions, based on a cleaning route, and the cleaning position may be the second cleaning position.

The instructions, when executed by the at least one processor individually or collectively, may further cause the robot to: identify the luring position based on a cleaning route, a position to be cleaned, a position that has been cleaned, and the search information.

The instructions, when executed by the at least one processor individually or collectively, may further cause the robot to: identify a luring time based on a cleaning route, an estimated cleaning time, and the search information, and the second signal may further notify of the luring time.

The instructions, when executed by the at least one processor individually or collectively, may further cause the robot to: identify a luring method based on a type of the at least one accessory device and the search information, and the second signal may further notify of the luring method.

The search information may include at least one from among position information of the pet, movement information of the pet, behavior information of the pet, or profile information of the pet, and the profile information of the pet may include at least one from among a type of the pet, a sex of the pet, an age of the pet, or a nature of the pet.

The instructions, when executed by the at least one processor individually or collectively, may further cause the robot to: change a cleaning route of the robot based on the search information, identify a next cleaning position based on the changed cleaning route, and identify the luring position of the pet based on updated search information corresponding to the next cleaning position.

The first signal and the second signal may be transmitted to a server through the communication circuitry, the third signal may be received by the robot from the server, and the server may be configured to manage and control a device within a home.

The at least one accessory device may include at least one from among a projector robot, a mood light, a food dispenser, or a pet care robot.

According to an aspect of the disclosure, a cleaning system includes: a robot including: communication circuity; a driver; memory storing instructions; and at least one processor including processing circuitry, wherein the at least one processor is configured to individually or collectively execute the instructions; and an accessory device including: a sensor; accessory communication circuitry; accessory memory storing accessory instructions; and at least one accessory processor including accessory processing circuitry, wherein the at least one accessory processor is configured to individually or collectively execute the accessory instructions, wherein the instructions, when executed by the at least one processor individually or collectively, cause the robot to: based on cleaning being started, transmit, to the accessory device through the communication circuitry, a first signal notifying of a start of cleaning and requesting a pet search, wherein the accessory instructions, when executed by the at least one accessory processor individually or collectively, cause the accessory device to: based on receiving the first signal from the robot, obtain search information regarding a pet based on data obtained through the sensor, and transmit, to the robot through the accessory communication circuitry, the search information, wherein the instructions, when executed by the at least one processor individually or collectively, further cause the robot to: based on receiving the search information from the accessory device, transmit, to the accessory device through the communication circuitry, a second signal notifying of a luring position of the pet based on a cleaning position and the search information, wherein the accessory instructions, when executed by the at least one accessory processor individually or collectively, further cause the accessory device to: based on receiving the second signal from the robot, identify a luring method for luring the pet to the luring position, and based on luring the pet to the luring position, transmit a third signal to the robot through the accessory communication circuitry, and wherein the instructions, when executed by the at least one processor individually or collectively, further cause the robot to: based on receiving the third signal indicating the pet was successfully lured to the luring position, control the driver to move the robot to the cleaning position and control the robot to start cleaning at the cleaning position.

The instructions, when executed by the at least one processor individually or collectively, may further cause the robot to: identify a first cleaning position, from among a plurality of cleaning positions, based on the search information, and the cleaning position may be the first cleaning position.

The instructions, when executed by the at least one processor individually or collectively, may further cause the robot to: identify a second cleaning position, from among a plurality of cleaning positions, based on a cleaning route, and the cleaning position may be the second cleaning position.

The instructions, when executed by the at least one processor individually or collectively, may further cause the robot to: identify the luring position based on a cleaning route, a position to be cleaned, a position that has been cleaned, and the search information.

The accessory device may include at least one from among a projector robot, a mood light, a food dispenser, or a pet care robot.

According to an aspect of the disclosure, a method of controlling a robot includes: based on cleaning being started, transmitting, to at least one accessory device, a first signal notifying of a start of cleaning and requesting a pet search; based on receiving search information regarding a pet obtained from the at least one accessory device, transmitting, to the at least one accessory device, a second signal notifying of a luring position of the pet based on a cleaning position and the search information; and based on receiving a third signal indicating the pet was successfully lured to the luring position, controlling the robot to move to the cleaning position and start cleaning at the cleaning position.

The method may further include: identifying a first cleaning position, from among a plurality of cleaning positions, based on the search information, and the transmitting the second signal may include transmitting, to the at least one accessory device, the second signal notifying of the luring position of the pet based on the first cleaning position and the search information.

The method may further include: identifying a second cleaning position from among a plurality of cleaning positions based on a cleaning route, and the transmitting the second signal may include transmitting, to the at least one accessory device, the second signal notifying of the luring position of the pet based on the second cleaning position.

The method may further include: identifying the luring position based on a cleaning route, a position to be cleaned, a position that has been cleaned, and the search information.

The method may further include: identify a luring time based on a cleaning route, an estimated cleaning time, and the search information, and the transmitting the second signal may include transmitting, to the at least one accessory device, the second signal notifying of the luring position and the luring time.

According to an aspect of the disclosure, a non-transitory computer-readable medium has instructions stored thereon, which when executed by at least one processor individually or collectively, cause the at least one processor to execute a method of controlling a robot, the method including: based on cleaning being started, transmitting, to at least one accessory device, a first signal notifying of a start of cleaning and requesting a pet search; based on receiving search information regarding a pet obtained from the at least one accessory device, transmitting, to the at least one accessory device, a second signal notifying of a luring position of the pet based on a cleaning position and the search information; and based on receiving a third signal indicating the pet was successfully lured to the luring position, controlling the robot to move to the cleaning position and start cleaning at the cleaning position.

### BRIEF DESCRIPTION OF THE DRAWINGS

The above and other aspects and features of specific embodiments of the disclosure will be made clearer from the following description taken in conjunction with the accompanying drawings, in which:

FIG. 1A is a diagram illustrating a relationship between a pet and a robot according to an embodiment;

FIG. 1B is a diagram illustrating a relationship between a pet and a robot according to an embodiment;

FIG. 1C is a diagram illustrating a relationship between a pet and a robot according to an embodiment;

FIG. 2 is a block diagram illustrating a configuration of a robot according to an embodiment;

FIG. 3 is a flowchart illustrating a control method of a robot according to an embodiment;

FIG. 4 is a flowchart illustrating a control method of a robot according to an embodiment;

FIG. 5 is a flowchart illustrating a control method of a robot according to an embodiment;

FIG. 6 is a sequence diagram illustrating an operational flow between a robot and at least one accessory device according to an embodiment;

FIG. 7 is a sequence diagram illustrating an operational flow between a robot, at least one accessory device, and a server according to an embodiment;

FIG. 8 is a block diagram illustrating a configuration of a server according to an embodiment;

FIG. 9 is a block diagram illustrating a configuration of an accessory device according to an embodiment;

FIG. 10 is a diagram illustrating an example of a pet luring method according to an embodiment;

FIG. 11 is a diagram illustrating an example of a pet luring method according to an embodiment; and

FIG. 12 is a diagram illustrating an example of a pet luring method according to an embodiment.

### DETAILED DESCRIPTION

The embodiments of the disclosure will be described in detail below with reference to the accompanying drawings.

Terms used in describing embodiments of the disclosure are general terms selected that are currently widely used considering their function herein. However, the terms may change depending on intention, legal or technical interpretation, emergence of new technologies, and the like of those skilled in the related art. Further, in certain cases, there may be terms arbitrarily selected, and in this case, the meaning of the term will be disclosed in greater detail in the corresponding description. Accordingly, the terms used herein are not to be understood simply as its designation (analyzed phone calls, messages, schedules, etc.) but based on the meaning of the term and the overall context of the disclosure.

In the disclosure, expressions such as “have”, “may have”, “include”, and “may include” are used to designate a presence of a corresponding characteristic (e.g., elements such as numerical value, function, operation, or component), and not to preclude a presence or a possibility of additional characteristics.

The expression at least one of A and/or B is to be understood as indicating any one of “A” or “B” or “A and B”.

Expressions such as “1st”, “2nd”, “first”, or “second” used in the disclosure may limit various elements regardless of order and/or importance, and may be used merely to distinguish one element from another element and not limit the relevant element.

When a certain element (e.g., a first element) is indicated as being “(operatively or communicatively) coupled with/to” or “connected to” another element (e.g., a second element), it may be understood as the certain element being directly coupled with/to the another element or as being coupled through other element (e.g., a third element).

A singular expression includes a plural expression, unless otherwise specified. It is to be understood that the terms such as “form” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

The term “module” or “part” used in the embodiments herein perform at least one function or operation, and may be implemented with hardware or software, or implemented with a combination of hardware and software. In addition, a plurality of “modules” or a plurality of “parts”, except for a “module” or a “part” which needs to be implemented with a specific hardware, may be integrated in at least one module and implemented as at least one processor.

In the disclosure, the term “user” may refer to a person using a robot or a device (e.g., artificial intelligence robot) using the robot.

The various elements and areas of the drawings have been schematically illustrated. Accordingly, the technical spirit of the disclosure is d by relative sizes and distances illustrated in the accompanied drawings.

An embodiment of the disclosure will be described in greater detail below with reference to the accompanied drawings.

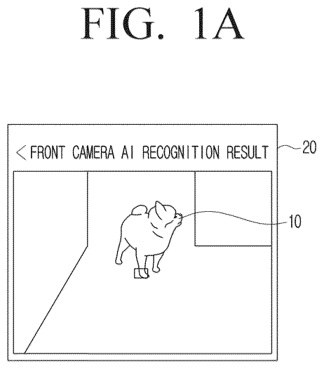

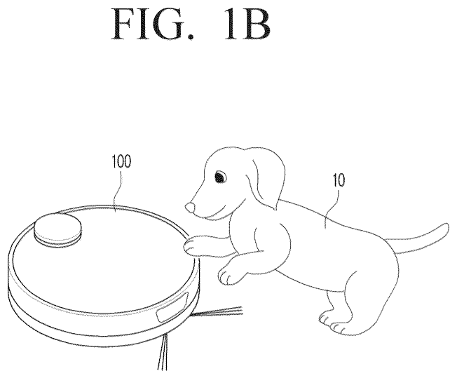

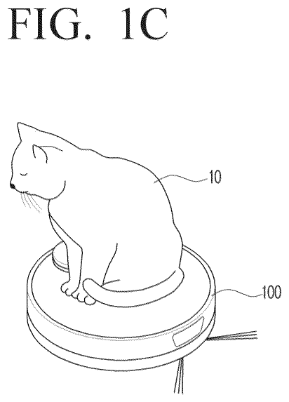

FIGS. 1A, 1B, and FIG. 1C are diagrams illustrating a relationship between a pet and a robot according to an embodiment.

According to an embodiment, a robot 100 may be implemented as a robot cleaner. The robot cleaner may be a home appliance that automatically cleans the floor, and may recognize a space and suction dust and filth using a sensor and artificial intelligence technology. However, embodiments of the disclosure are not limited thereto, and the robot 100 may be implemented as service robots of various types such as a delivery robot, a guide robot, a serving robot, and/or a companion robot. However, in the disclosure, an example of the robot 100 being implemented as the robot cleaner (or cleaning robot) may be described for convenience of description.

According to an embodiment, restrictions to a cleaning route of the robot 100 may be generated due to pets.

According to an example in FIG. 1A, a part of the body of a pet 10 may be recognized as an obstacle making traveling of the robot 100 difficult. For example, a part of the body of the pet 10 may be recognized as an obstacle using artificial intelligence technology in an image captured through a camera provided in the robot 100 as shown in FIG. 1A.

According to an example in FIG. 1B, traveling of the robot 100 may be difficult if a pet is playing with the robot 100.

According to an example in FIG. 1C, an operation of the robot 100 may stop if a pet has climbed on top of the robot 100.

In addition thereto, there may be instances where a pet has removed the robot 100 outside a home.

Various embodiments of luring a pet to a location that does not interfere with cleaning to prevent limitations occurring on the cleaning route of the robot 100 for various reasons as described above will be described below.

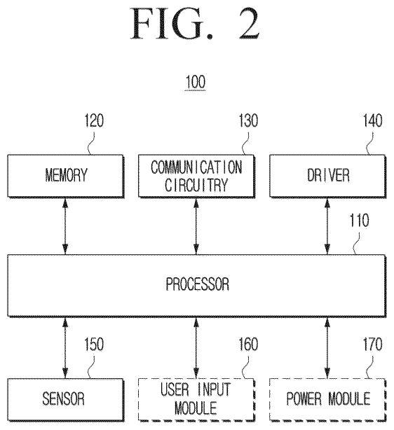

FIG. 2 is a block diagram illustrating a configuration of a robot according to an embodiment.

Referring to FIG. 2, the robot 100 may include at least one processor 110, a memory 120, communication circuitry 130, a driver 140, a sensor 150, a user input module 160, and a power module 170. The at least one processor 110, the memory 120, the communication circuitry 130, the driver 140, the sensor 150, the user input module 160, and the power module 170 may be electronically and/or operably coupled with each other by an electronic component such as a communication bus.

According to an embodiment, the hardware of the robot 100 being operably coupled may mean direct connection or indirect connection between the hardware being established via wired or wireless means for a second hardware to be controlled by a first hardware from among the hardware. Although the drawing is shown based on different blocks, embodiments of the disclosure are not limited thereto, and a portion from among the hardware in FIG. 2 (e.g., at least a portion of the processor 110, the memory 120, the communication circuitry 130, the driver 140, the sensor 150, the user input module 160, and the power module 170) may be included in a single integrated circuit such as a system on a chip (SoC). Types and/or number of hardware included in the robot 100 may not be limited by that shown in FIG. 2. For example, the robot 100 may include a portion from among the hardware components shown in FIG. 2.

According to an embodiment, the processor 110 of the robot 100 may include hardware for processing data based on one or more instructions. The hardware for processing data may include, for example, an arithmetic and logic unit (ALU), a floating point unit (FPU), a field programmable gate array (FPGA), a central processing unit (CPU), and/or an application processor (AP). The number of processors 110 may be one or more. For example, the processor 110 may have a structure of a multi-core processor such as a dual core, a quad core, or a hexa core.

The processor 110 may control operations of the robot 100 by executing instructions stored in the memory 120. For example, the processor 110 may correspond to a plurality of processors that divide and collectively perform a plurality of operations between the processors.

The central processing unit (CPU) may be a generic-purpose processor capable of performing not only general computations, but also artificial intelligence computations, and may effectively execute complex programs through a multi-tiered cache structure. The CPU may be advantageous in a series processing method which allows for an organic connection between a previous calculation result and a following calculation result to be possible through a sequential calculation. The generic-purpose processor may not be limited to the above-described example except for when specified as the above-described CPU.

The graphic processing unit (GPU) may be a processor for mass computation such as a floating point computation used in graphics processing, and perform a large-scale computation by integrating cores in mass in parallel. Specifically, the GPU may be advantageous in a parallel processing method such as a convolution computation compared to the CPU. In addition, the GPU may be used as a co-processor for supplementing a function of the CPU. The processor for mass computation may not be limited to the above-described example except for when specified as the above-described GPU.

The neural processing unit (NPU) may be a processor which specializes in an artificial intelligence computation using an artificial neural network, and may implement each layer that forms the artificial neural network with hardware (e.g., silicon). At this time, because the NPU is designed specialized according to a required specification of a company, there is a lower degree of freedom compared to the CPU or the GPU, but the NPU may efficiently process the artificial intelligence computation demanded by the company. As a processor specializing in the artificial intelligence computation, the NPU may be implemented in various forms such as a tensor processing unit (TPU), an intelligence processing unit (IPU), and a vision processing unit (VPU). The artificial intelligence processor may not be limited to the above-described example except for when specified as the above-described NPU.

According to an embodiment, the memory 120 of the robot 100 may include a hardware component for storing data and/or instructions input in and/or output from the processor 110. The memory 120 may be implemented in a form of a memory embedded in the robot 100 according to data storage use, or implemented in a form of a memory attachable to or detachable from the robot 100. For example, data for driving the robot 100 may be stored in the memory embedded in the robot 100, and data for an expansion function of the robot 100 may be stored in the memory attachable to or detachable from the robot 100. The memory embedded in the robot 100 may be implemented as at least one of a volatile memory (e.g., a dynamic random access memory (DRAM), a static RAM (SRAM), or a synchronous dynamic RAM (SDRAM)), or a non-volatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., NAND flash or NOR flash), a hard disk drive (HDD) or a solid state drive (SSD)). In addition, in the case of the memory attachable to or detachable from the electronic apparatus 100, the memory may be implemented in a form such as, for example, and without limitation, a memory card (e.g., a compact flash (CF), a secure digital (SD), a micro secure digital (micro-SD), a mini secure digital (mini-SD), an extreme digital (xD), a multi-media card (MMC), etc.), an external memory (e.g., a USB memory) connectable to a USB port, or the like.

According to an embodiment, in the memory 120 of the robot 100, one or more instructions (or commands) indicating computations and/or operations for the processor 110 to perform with data may be stored. A set of one or more instructions may be referred to as firmware, an operating system, a process, a routine, a sub-routine, and/or an application. For example, the robot 100 and/or the processor 110 may perform various operations when a set of a plurality of instructions distributed in a form of the operating system, firmware, a driver, and/or the application is executed. Herein, the application being installed in the robot 100 may mean that the one or more instructions provided in application form are stored in the memory 120 of the robot 100, and that the one or more applications are stored in a format (e.g., a file having an extension designated by the operating system of the robot 100) executable by the processor 110 of the robot 100.

The at least one processor 110 may control to process input data according to a predefined operation rule or an artificial-intelligence model (AI model) stored in the memory 120. The pre-defined operation rule or the AI model are characterized by being created through learning (or training). The being created through learning may mean a pre-defined operation rule or an AI model of a desired feature being created by applying a learning algorithm to a plurality of training data. The learning may be carried out in the device itself in which the artificial intelligence according to the disclosure is performed, or carried out through a separate server/system.

The AI model may be configured with a plurality of neural network layers. At least one layer may have at least one weight value, and perform a computation of the layer through a computation result of a previous layer and at least one defined computation. Examples of the neural network may include a Convolutional Neural Network (CNN), a Deep Neural Network (DNN), a Recurrent Neural Network (RNN), a Restricted Boltzmann Machine (RBM), a Deep Belief Network (DBN), a Bidirectional Recurrent Deep Neural Network (BRDNN), a Deep-Q Networks, and a Transformer, and a neural network in the disclosure may not be limited to the above-described examples except for when specified.

The learning algorithm may be a method for training a predetermined target device (e.g., robot) to make decisions or predictions on its own using the plurality of training data. Examples of the learning algorithm may include supervised learning, unsupervised learning, semi-supervised learning, or reinforcement learning, and the learning algorithm of embodiments of the disclosure is not limited to the above-described examples except for when specified.

The communication circuitry 130 of the robot 100 according to an embodiment may include hardware to support transmitting and/or receiving of electric signals between the robot 100 and an external device (e.g., server). For example, the communication circuitry 130 may perform communication with an external device, an external storage medium (e.g., USB memory), an external server (e.g., WEBHARD), and the like through communication methods such as, for example, and without limitation, Bluetooth, an AP based Wi-Fi (e.g., Wi-Fi, wireless LAN network), ZigBee, a wired/wireless local area network (LAN), a wide area network (WAN), Ethernet, IEEE 1394, a high-definition multimedia interface (HDMI), a universal serial bus (USB), a mobile high-definition link (MHL), Audio Engineering Society/European Broadcasting Union (AES/EBU), Optical, Coaxial, or the like. The communication circuitry 130 according to an example may perform communication with another robot, an external server and/or a remote control device, or the like.

The driver 140 of the robot 100 according to an embodiment may be a device which can drive the robot 100. The driver 140 may adjust a driving direction and a driving speed according to control of the processor 110, and the driver 140 according to an example may include a power generating device (e.g., a gasoline engine, a diesel engine, a liquefied petroleum gas (LPG) engine, an electric motor, or the like according to fuel (or energy source) used) which generates power for the robot 100 to drive, a steering device (e.g., manual steering, hydraulics steering, electronic control power steering (EPS), etc.) for adjusting the driving direction, a driving device (e.g., a wheel, a propeller, etc.) which drives the robot 100 according to power, and the like. Here, the driver 140 may be modified and implemented according to a driving type (e.g., a wheel type, a walking type, a flying type, etc.) of the robot 100.

The sensor 150 of the robot 100 according to an example may sense various information. The sensor 150 may be implemented as sensors of various types. For example, the sensor 150 may include at least one sensor from among a camera, a time of flight (ToF) sensor, an ultrasonic sensor, a radio detection and ranging (RADAR) sensor, a photodiode sensor, a proximity sensor, a passive infrared (PIR) sensor, a pin hole sensor, a pin hole camera, an infrared body detecting sensor, a complementary metal oxide semiconductor (CMOS) image sensor, a heat detection sensor, an optical sensor, and a motion detection sensor. For example, the camera may include at least one from among a typical (or basic) camera and an ultra-wide angle camera.

The sensor 150 may include a touch sensor which has a form such as a touch film, a touch sheet, and a touch pad and detects a touch operation.

The sensor 150 may include at least one from among the camera, a microphone, a CO2 sensor, and an air pressure sensor. The camera may convert a captured image into an electric signal and generate image data based on the converted signal. For example, the camera may include at least one from among a typical (or basic) camera, a depth camera, and an ultra-wide angle camera. The microphone may be a configuration for receiving input of a user voice or other sounds and converting to audio data. The CO2 sensor may be a sensor for measuring concentration of carbon dioxide. The air pressure sensor may be a sensor for sensing surrounding pressure.

The sensor 150 may further include at least one sensor capable of sensing surrounding light, surrounding temperature, and incident direction of light. In this case, the sensor 150 may be implemented as a light sensor, a temperature detection sensor, a light amount sensing layer, or a camera.

The sensor 150 may further include at least one from among an acceleration sensor (or a gravity sensor), a geomagnetic sensor, or a gyro sensor. For example, the acceleration sensor may be a three-axis acceleration sensor. The three-axis acceleration sensor may measure gravity acceleration for each axis, and provide raw data to the processor 110. The geomagnetic sensor or gyro sensor may be used in obtaining orientation information. Here, the orientation information may include at least one from among roll information, pitch information, or yaw information.

The user input module 160 of the robot 100 according to an embodiment may be implemented as a device such as a button or a touch pad, or may be implemented as a touch screen or the like capable of performing a display function together with an operation input function.

The power module 170 of the robot 100 according to an embodiment may be a module that provides energy for the robot 100 to operate. For example, the power module 170 may receive power through at least one from among a battery, a fuel cell, energy harvesting, and wireless power, and supply energy for the robot 100 to operate. For example, the power module 170 may convert output voltage of a battery to voltage required by each component of the robot using a voltage converter, monitor a state of the battery using a battery management system, and prevent overcharging and over discharging.

In addition to the above, the robot 100 may further include a speaker, a microphone, a display, and the like according to an implementation. For example, the speaker may be a configuration that outputs not only various audio data, but also various notification sounds, voice messages, or the like.

According to an embodiment, the robot 100 may be pre-stored with map data corresponding to a space in order to drive in the space, and drive in the space by performing route planning based therefrom. According to an example, the map data may be map data of various types such as, for example, and without limitation, a traversability map, a distance map, and the like.

The processor 110 according to an example may obtain free space map based on simultaneous localization and mapping (SLAM). Here, the SLAM may mean estimating a position of the robot 100 while simultaneously generating a map. For example, the processor 110 may obtain the free space map based on data obtained through the sensor 150. The processor 110 according to an example may identify the position of the robot 100, and obtain the free space map using various sensors provided in the robot 100 such as, for example, and without limitation, a camera, a LiDAR sensor, an infrared sensor, an ultrasonic sensor, and the like. Here, the free space map may be in a form that classified a space as at least one from among an occupied space, a free space, or an unknown space.

Then, the processor 110 may obtain the distance map based on information on a free space included in the free space map and information obtained through the sensor 150 (e.g., LiDAR sensor) while the robot 100 is driving. Here, the distance map may be in a form that stores distance to an obstacle and a probability value of an obstacle. The processor 110 according to an example may drive in a space based on the distance map.

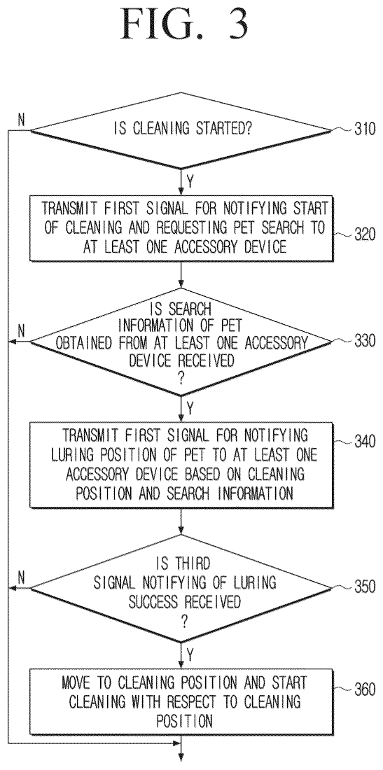

FIG. 3 is a flowchart illustrating a control method of a robot according to an embodiment.

Although each of the operations in the embodiment below can be performed sequentially, the operations are not necessarily performed in sequential order. For example, the order of each of the operations may be changed, and at least two operations may be performed in parallel.

According to an embodiment, it may be understood as operation 310 to operation 360 being performed in the processor 110 of the robot 100.

Referring to FIG. 3, in operation 310, the robot 100 according to an embodiment may identify whether cleaning is started. For example, the robot 100 may start cleaning according to at least one event from among pressing of a start button, a voice command, arrival of a reserved time, and automatic detection function (e.g., detecting dust or degree of contamination of a floor).

When cleaning is started according to an embodiment (310:Y), in operation 320, the robot 100 according to an embodiment may transmit a first signal to at least one accessory device for notifying a start of cleaning and requesting a pet search. For example, the robot 100 may transmit the first signal to at least one from among a server or at least one accessory device.

According to an example, the robot 100 may transmit the first signal to the at least one accessory device. For example, the robot 100 may perform communication with an accessory device through communication methods such as Bluetooth and Wi-Fi.

According to an example, the robot 100 may transmit the first signal to the server. For example, the robot 100 may perform communication with the server through communication methods such as Wi-Fi. For example, the server may manage a plurality of devices positioned in a pre-set space by a user. The pre-set space may be various spaces such as a home, a working space, or a space of the user within an office. The server may be implemented as a cloud server, but is not limited thereto. The plurality of devices may be various internet or things (IoT) devices managed from the server. For example, the plurality of devices may include at least one accessory device. For example, the at least one accessory device may include at least one from among a projector robot, a mood light, a snack dispenser, or a pet care robot.

In operation 330, the robot 100 according to an embodiment may identify whether search information of a pet obtained from the at least one accessory device is received.

The robot 100 according to an example may receive the search information of a pet from at least one from among the server, the at least one accessory device, or the memory 120. For example, the robot 100 may receive sensing data from the at least one accessory device, obtain search information based therefrom, and receive the search information collected from the accessory device, but has been described as the search information being received for convenience of description.

The search information of a pet according to an example may include at least one from among position information, movement information, or behavior information of the pet.

The position information of the pet may include position information on a spatial map.

The movement information of the pet may include at least one information from among movement direction, movement distance, and movement speed of the pet.

The behavior information of the pet may include at least one information from among a sleep state, a feeding state, or a play state.

However, in order to lure the pet according to an embodiment, not only the search information, but also basic information (or profile information) of the pet may be referenced. The basic information of the pet may include at least one from among type, sex, age, or nature (e.g., liveliness/well-behaved/fierceness) of the pet. For convenience of description below, the search information of the pet will be described as also including the basic information.

The robot 100 according to an example may obtain the search information of a pet from sensing data received from an accessory device or sensing data obtained through the sensor 150. For example, the robot 100 may obtain the search information of a pet by applying at least one from among a pre-set algorithm or a pre-set formula to at least one from among a captured image received from an accessory device or a captured image obtained through the sensor 150. For example, the robot 100 may obtain the search information of a pet by inputting the captured image in an artificial intelligence model.

When the camera is used according to an example, at least one from among a position of a pet, a state of the pet, or a movement route of the pet may be obtained.

When smart tag technology is used according to an example, at least one from among a position or a movement route of the pet may be obtained using a BLE or UWB based smart tag necklace worn by the pet.

When the microphone is used according to an example, at least one from among a position or direction of the pet may be obtained based on a direction of sound input through the microphone.

When the search information of the pet is received according to an embodiment (330:Y), in operation 340, the robot 100 according to an embodiment may transmit a second signal to the at least one accessory device providing notice of a luring position of the pet based on a cleaning position and the search information. For example, the robot 100 may transmit the second signal to at least one from among the server or the at least one accessory device.

According to an example, the robot 100 may identify the luring position of the pet based on at least one from among a cleaning route, a next cleaning position (or a position subject to cleaning), a position that completed cleaning, estimated cleaning time, or the search information. For example, the robot 100 may identify the last position in the cleaning route as the luring position, or identify the position that completed cleaning as the luring position. For example, the luring position may include coordinate information on the spatial map.

According to an embodiment, the robot 100 may identify a luring time of a pet based on at least one from among the cleaning route, the estimated cleaning time, estimated movement time, and the search information (e.g., position information of the pet). For example, the robot 100 may identify the luring time of the pet by predicting a cleaning end time of a current cleaning position and a time-point at which feeding of the pet is ended when the pet is feeding at the next cleaning position. In this case, the robot 100 may transmit the second signal providing notice of the luring position and the luring time. According to an example, the robot 100 may identify an estimated cleaning time corresponding to a current cleaning location based on at least one from among a size, a degree of contamination, or a cleaning method of the cleaning location. According to an example, the robot 100 may identify the estimated movement time based on the current cleaning location, the distance between the net cleaning locations, and the movement speed of the robot 100.

According to an embodiment, the robot 100 may identify the luring method of the pet based on the type of the at least one accessory device and the search information. For example, the robot 100 may identify at least one from among an output of multimedia (e.g., image, music), output of different sex pet sounds, provide a laser pointer play, provide snacks, or a method designated by the user as the luring method. In this case, the robot 100 may transmit the second signal notifying the at least one accessory of the luring position and the luring method to the server or the at least one accessory. However, according to an example, the luring method may be identified in the accessory devices.

According to an embodiment, the robot 100 may transmit the second signal providing the luring position, the luring time, and the luring method to the server or to the at least one accessory device.

In operation 350, the robot 100 according to an embodiment may identify whether a third signal notifying of luring success is received. For example, the robot 100 may receive the third signal from at least one from among the server or the at least one accessory device.

When the third signal is received according to an embodiment (350:Y), in operation 360, the robot 100 according to an embodiment may move to the cleaning position and start cleaning with respect to the cleaning position.

According to an example, the robot 100 may start cleaning by operating a brush and/or a suction function according to a cleaning mode set automatically or manually. For example, the cleaning mode may include at least one from among an auto mode, a spot cleaning mode, an edge cleaning mode, a turbo mode, a quiet mode, or a mopping mode. According to an example, the robot 100 may automatically return to a charging dock when cleaning is completed or a battery of the robot is low.

The robot 100 according to an embodiment may re-try the pet search until a pre-set number of times is reached when failing in the pet search. The robot 100 according to an example may identify a failure in pet search based on at least one from among sensing data obtained from the sensor 150 or a luring failure notification signal received from the at least one accessory device.

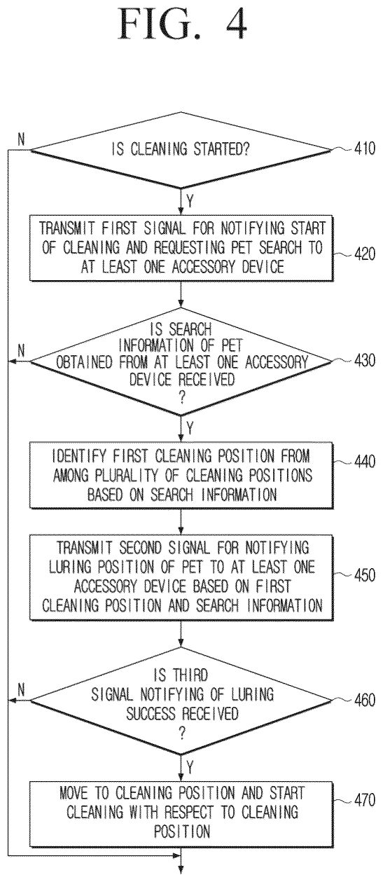

FIG. 4 is a flowchart illustrating a control method of a robot according to an embodiment.

In the embodiment below, each of the operations may be performed sequentially, but the operations may not be necessarily performed in sequential order. For example, the order of each of the operations may be changed, and at least two operations may be performed in parallel.

According to an embodiment, operation 410 to operation 470 may be understood as being performed in the processor 110 of the electronic device 100.

Detailed descriptions of operations that overlap with the operations shown in FIG. 3 from among operation 410 to operation 470 will be omitted.

Referring to FIG. 4, in operation 410, the robot 100 according to an embodiment may identify whether cleaning is started.

When cleaning is started according to an embodiment (410:Y), in operation 420, the robot 100 according to an embodiment may transmit a first signal for notifying of a start of cleaning and requesting a pet search to at least one accessory device. For example, the robot 100 may transmit the first signal to at least one from among the server or the at least one accessory device.

In operation 430, the robot 100 according to an embodiment may identify whether search information of a pet obtained from the at least on accessory device is received. For example, the robot 100 may receive the search information of the pet from at least one from among the server or the at least one accessory device.

When the search information of the pet is received according to an embodiment (430:Y), in operation 440, the robot 100 according to an embodiment may identify a first cleaning position from among a plurality of cleaning positions based on the search information. According to an example, the robot 100 may change (e.g., correct) a cleaning route based on the search information of the pet, and identify the first cleaning position which is the next cleaning position based on the corrected cleaning route. For example, the robot 100 may change the cleaning route so that a space in which the pet is sleeping in is not cleaned for a certain time when the pet is in a specific state (e.g., sleeping state).

In operation 450, the robot 100 according to an embodiment may transmit a second signal for notifying a luring position of the pet to the at least one accessory device based on the first cleaning position and the search information. For example, the robot 100 may transmit the second signal to at least one from among the server or the at least one accessory device.

In operation 460, the robot 100 according to an embodiment may identify whether a third signal notifying of luring success is received. For example, the robot 100 may receive the third signal from at least one from among the server or the at least one accessory device.

When the third signal is received according to an embodiment (460:Y), in operation 470, the robot 100 according to an embodiment may move to the cleaning position and start cleaning with respect to the cleaning position.

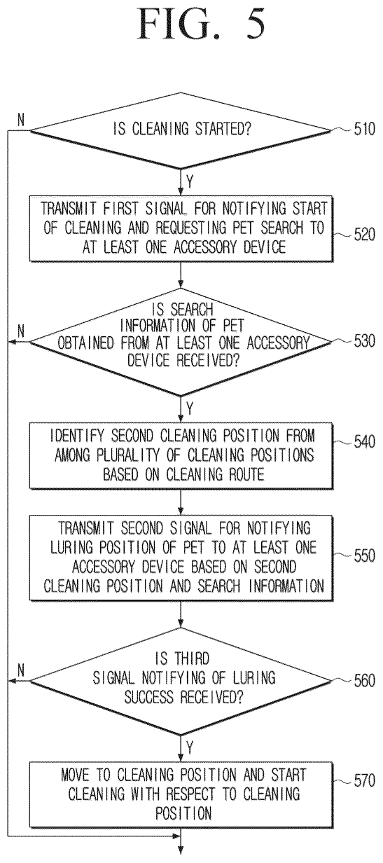

FIG. 5 is a flowchart illustrating a control method of a robot according to an embodiment.

Although each of the operations in the embodiment below can be performed sequentially, the operations are not necessarily performed in sequential order.

According to an embodiment, operation 510 to operation 570 may be understood as being performed in the processor 110 of the electronic device 100.

Detailed descriptions of operations that overlap with the operations shown in FIG. 3 from among operation 510 to operation 570 will be omitted.

Referring to FIG. 5, in operation 510, the robot 100 according to an embodiment may identify whether cleaning is started.

When cleaning is started according to an embodiment (510:Y), in operation 520, the robot 100 according to an embodiment may transmit a first signal for notifying of a start of cleaning and requesting a pet search to at least one accessory device. For example, the robot 100 may transmit the first signal to at least one from among the server or the at least one accessory device.

In operation 530, the robot 100 according to an embodiment may identify whether search information of a pet obtained from the at least on accessory device is received. For example, the robot 100 may receive the search information of the pet from at least one from among the server or the at least one accessory device.

When the search information of the pet is received according to an embodiment (530:Y), in operation 540, the robot 100 according to an embodiment may identify a second cleaning position which is the next cleaning position from among the plurality of cleaning positions based on a cleaning route. For example, the cleaning route may be an optimal route (e.g., a pre-stored route optimized to a home space and a movement route of the robot 100) calculated based on a map corresponding to a cleaning space (e.g., home) when starting cleaning and a current position (e.g., charging dock) of the robot 100.

In operation 550, the robot 100 according to an embodiment may transmit a second signal for notifying a luring position of the pet to the at least one accessory device based on the second cleaning position and the search information. For example, the robot 100 may transmit the second signal to at least one from among the server or the at least one accessory device.

In operation 560, the robot 100 according to an embodiment may identify whether a third signal notifying of luring success is received. For example, the robot 100 may receive the third signal from at least one from among the server or the at least one accessory device.

When the third signal is received according to an embodiment (560:Y), in operation 570, the robot 100 according to an embodiment may move to the cleaning position and start cleaning with respect to the cleaning position.

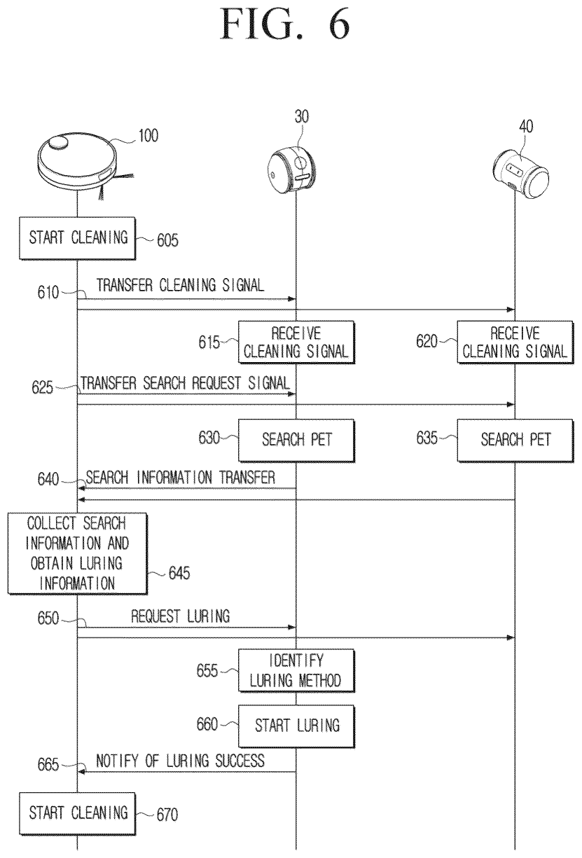

FIG. 6 is a sequence diagram illustrating an operational flow between a robot and at least one accessory device according to an embodiment.

Although each of the operations in the embodiment below can be performed sequentially, the operations are not necessarily performed in sequential order. For example, the order of each of the operations may be changed, and at least two operations may be performed in parallel.

Detailed descriptions of operations that overlap with the operations shown in FIG. 3 from among operation 610 to operation 670 will be omitted.

Referring to FIG. 6, when cleaning is started in operation 605, in operation 610, the robot 100 according to an embodiment may transfer a cleaning signal (or first signal) to a plurality of accessory devices 30 and 40. For example, a first accessory device 30 may be implemented as the projector robot, and a second accessory device 40 may be implemented as the pet care robot.

In operations 615 and 620, the cleaning signal may be received in each of the first accessory device 30 and the second accessory device 40 according to an embodiment. If at least one from among the first accessory device 30 and the second accessory device 40 is in a turned-off state (or a power saving state) according to an example, the same may be activated based on the cleaning signal. “Being activated” may be a state in which the first accessory device 30 and the second accessory device 40 are able to immediately perform their proper functions (e.g., turning-on of a projector function).

In operation 625, the robot 100 according to an embodiment may transfer a pet search request signal (or second signal) to the first accessory device 30 and the second accessory device 40. The robot 100 according to an example may transfer the search request signal while simultaneously performing the pet search using the sensor 150.

In operations 630 and 635, the first accessory device 30 and the second accessory device 40 according to an embodiment may perform, when the search request signal is received, the pet search using the provided sensor.

In operation 640, the first accessory device 30 and the second accessory device 40 according to an embodiment may transmit the search information to the robot 100. For example, the first accessory device 30 and the second accessory device 40 may transmit sensing data, or transmit the search information obtained based on the sensing data to the robot 100.

In operation 645, the robot 100 according to an embodiment may collect the search information received from the first accessory device 30 and the second accessory device 40 and the search information obtained using the sensor 150, and obtain luring information. For example, the luring information may include at least one from among the luring position or the luring time.

In operation 650, the robot 100 according to an embodiment may request the first accessory device 30 and the second accessory device 40 to lure the pet based on the luring information. According to an example, it may be assumed that an accessory device capable of luring a pet to a determined luring position from among the first accessory device 30 and the second accessory device 40 is the first accessory device 30. For example, whether the first accessory device 30 and the second accessory device 40 are capable of luring a pet to a determined luring position may be determined based on at least one from among the positions, the functions, or the current states of the first accessory device 30 and the second accessory device 40.

In operation 655, the first accessory device 30 according to an embodiment may identify a luring method for luring the pet. According to an example, the first accessory device 30 may determine the luring method based on at least one from among the position, the function, and the current state and a type of the pet. For example, the first accessory device 30 may determine the luring method of projecting an image of a butterfly flying about at a living room wall using a projector function if the pet is a cat.

In operation 660, the first accessory device 30 according to an embodiment may start the luring of the pet. For example, the first accessory device 30 may project the image of the butterfly flying about at the living room wall.

In operation 665, the first accessory device 30 according to an embodiment may transfer, when the pet moves to the luring position, a signal notifying of luring success to the robot 100. For example, the first accessory device 30 may identify whether the pet has been moved to the luring position using the provided sensor. For example, whether the pet is moved to the luring position may be identified based on at least one from among a captured image obtained through the camera, a sound (e.g., pet sound) obtained through the microphone, or smart tag information. For example, the first accessory device 30 may receive information on whether the pet is moved to the luring position from an external device (e.g., another accessory device).

In operation 670, the robot 100 according to an embodiment may start cleaning when a luring success notifying signal (or third signal) of the pet is received. For example, the robot 100 may receive the luring success notifying signal from at least one from among the first accessory device 30 or another device (e.g., another accessory device).

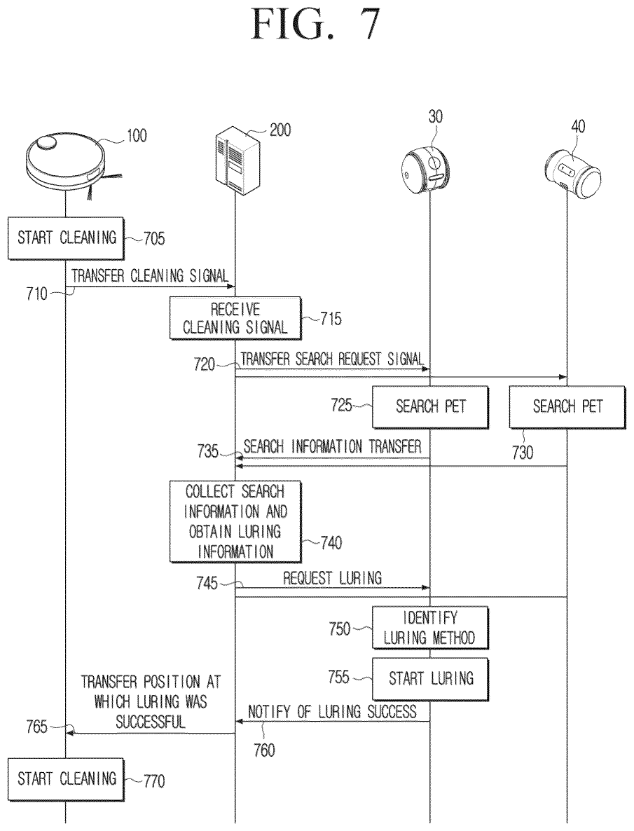

FIG. 7 is a sequence diagram illustrating an operational flow between a robot, at least one accessory device, and a server according to an embodiment.

Although each of the operations in the embodiment below can be performed sequentially, the operations are not necessarily performed in sequential order. For example, the order of each of the operations may be changed, and at least two operations may be performed in parallel.

Detailed descriptions of operations that overlap with the operations shown in FIG. 6 from among operation 710 to operation 770 will be omitted.

Referring to FIG. 7, when cleaning is started in operation 705, in operation 710, the robot 100 according to an embodiment may transmit a cleaning signal (or first signal) notifying a start of cleaning to a server 200. The robot 100 according to an example may transmit the pet search request signal to the server 200 after transmitting the cleaning signal. The robot 100 according to an example may perform, while simultaneously transferring a cleaning start signal or the pet search request signal, the pet search using the sensor 150.

In operation 715, the server 200 according to an embodiment may receive the cleaning signal, and in operation 720, the server 200 according to an embodiment may transfer the pet search request signal to the first accessory device 30 and the second accessory device 40. It may be possible for the server 200 according to an example to transmit, when the cleaning signal is received, the pet search request signal after first transferring the cleaning signal to the first accessory device 30 and the second accessory device 40.

In operations 725 and 730, the first accessory device 30 and the second accessory device 40 according to an embodiment may perform, when the search request signal is received, the pet search using the provided sensor.

In operation 735, the first accessory device 30 and the second accessory device 40 according to an embodiment may transmit the search information to the server 200. For example, the first accessory device 30 and the second accessory device 40 may transmit sensing data, or transmit the search information obtained based on the sensing data to the server 200.

In operation 740, the server 200 according to an embodiment may collect the search information received from the first accessory device 30 and the second accessory device 40, and obtain the luring information. For example, the luring information may include at least one from among the luring position or the luring time.

In operation 745, the server 200 according to an embodiment may request the luring of the pet to the first accessory device 30 and the second accessory device 40 based on the luring information. For example, the server 200 may request the luring of the pet by transmitting the luring position and the luring time to at least one from among the first accessory device 30 or the second accessory device 40.

In operation 750, the first accessory device 30 according to an embodiment may identify the luring method for the luring of the pet. The first accessory device 30 according to an example may determine the luring method based on at least one from among the position, the function, and the current state and the type of the pet.

In operation 755, the first accessory device 30 according to an embodiment may start the luring of the pet. For example, the first accessory device 30 may project the image of the butterfly flying about at the living room wall.

In operation 760, the first accessory device 30 according to an embodiment may transfer, when the pet moves to the luring position, the signal notifying of luring success to the server 200.

In operation 765, the server 200 according to an embodiment may transfer, when the signal notifying of luring success of the pet is received, information on a position at which luring was successful to the robot 100.

In operation 770, the robot 100 according to an embodiment may start cleaning when information on the position at which luring was successful is received from the server 200. For example, the robot 100 may check the position at which luring was successful and start cleaning according to the cleaning route or start cleaning by correcting the cleaning route.

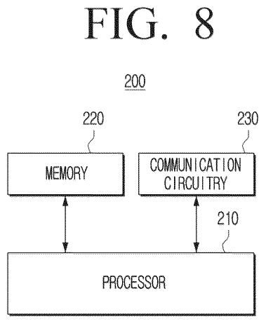

FIG. 8 is a block diagram illustrating a configuration of a server according to an embodiment.

The server 200 according to an embodiment may manage a plurality of devices positioned by the user in a pre-set space. The pre-set space may be various spaces such as a home, a working space, or a space of the user within an office. The server 200 may be implemented as the cloud server, but is not limited thereto. The plurality of devices may be various internet of things (IoT) devices managed in the server 200. For example, the plurality of devices may include at least one accessory device.

Referring to FIG. 8, the server 200 may include at least one processor 210, a memory 220, and communication circuitry 230. The at least one processor 210, the memory 220, and the communication circuitry 230 may be electronically and/or operably coupled with each other by an electronic component such as a communication bus.

The configurations of the at least one processor 210, the memory 220, and the communication circuitry 230 may be implemented identically/similarly with the at least one processor 110, the memory 120, and the communication circuitry 130 shown in FIG. 2.

According to an embodiment, the processor 210 may transmit, based on a cleaning signal notifying a start of cleaning being received from the robot 100, a pet search request signal to the at least one accessory device through the communication circuitry 230. According to an example, it may be possible for the server 200 to transmit, when the cleaning signal is received, the pet search request signal after first transferring the cleaning signal to the at least one accessory device.

According to an embodiment, the processor 210 may collect, based on receiving the search information from the at least one accessory device, the received search information and obtain luring information. For example, the luring information may include at least one from among the luring position or the luring time.

According to an embodiment, the processor 210 may request a luring of a pet to the at least one accessory device. For example, the processor 210 may request the luring of a pet by transmitting the luring position and the luring time to the at least one accessory device.

According to an embodiment, the processor 210 may transfer, based on a luring success notifying signal of the pet being received from the at least one accessory device, information on a position at which luring was successful to the robot 100. In this case, the robot 100 may check the position at which luring was successful and start cleaning according to a cleaning route or start cleaning by correcting the cleaning route.

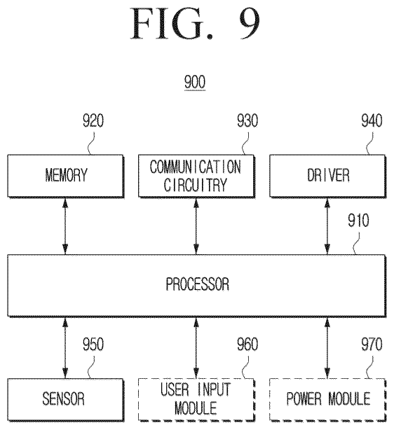

FIG. 9 is a block diagram illustrating a configuration of an accessory device according to an embodiment.

An accessory device 900 according to an embodiment may be implemented as at least one from among the projector robot, the mood light, the snack dispenser, or the pet care robot.

Referring to FIG. 9, the accessory device 900 may include at least one from among at least one processor 910, a memory 920, a communication circuitry 930, a driver 940, a sensor 950, a user input module 960, or a power module 970. The at least one processor 910, the memory 920, the communication circuitry 930, the driver 940, the sensor 950, the user input module 960, and/or the power module 970 may be electronically and/or operably coupled with each other by an electronic component such as a communication bus.

The configurations of the at least one processor 910, the memory 920, the communication circuitry 930, the driver 940, the sensor 950, the user input module 960, and/or the power module 970 may be implemented identically/similarly with the at least one processor 110, the memory 120, the communication circuitry 130, the driver 140, the sensor 150, the user input module 160, and/or the power module 170 shown in FIG. 2.

According to an embodiment, the processor 910 may execute a function for luring a pet based on a request received from at least one from among the robot 100 or the server 200. The processor 910 according to an example may lure the pet with various methods according to a type (or function) of the accessory device 900. For example, the processor 910 may lure the pet using at least one from among outputting multimedia (e.g., images, music), outputting different sex pet sounds, providing laser pointer play, or providing snacks.

According to an example, it may be assumed that the accessory device 900 includes the projection function. In this case, when a request signal of “lure cat with an image of a butterfly flying about the living room” is received from at least one from among the robot 100 or the server 200, the processor 910 may move to the living room and lure the cat by projecting the image of the butterfly flying about at the living room wall.

According to an embodiment, the processor 910 may identify whether the luring of pet to the luring position is successful based on sensing data obtained by using the sensor 950. According to an example, the processor 910 may transmit, based on identifying that the luring of pet has been successful, a luring success notifying signal to at least one from among the robot 100 or the server 200. According to an example, the processor 910 may transmit, based on identifying that the luring of pet has failed, the luring failure notification signal to at least one from among the robot 100 or the server 200.

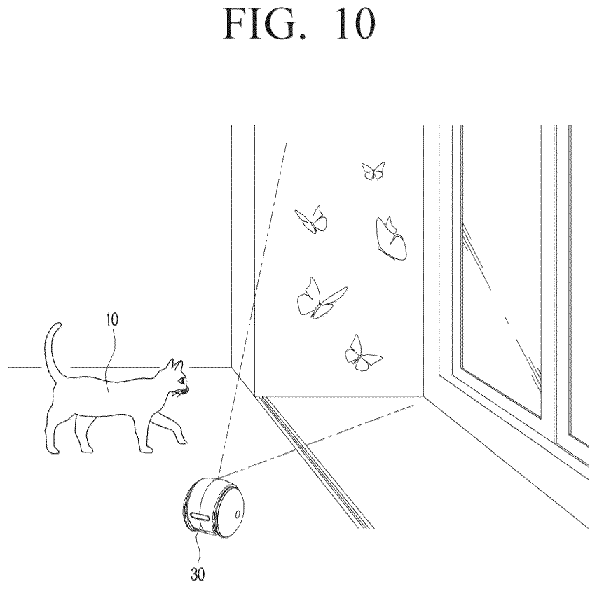

FIG. 10 to FIG. 12 are diagrams illustrating an example of a pet luring method according to an embodiment.

According to an embodiment, the robot 100 may transmit, when cleaning is started, a cleaning start notification to an accessory device 30, and start search of pets in the surroundings.

According to an embodiment, when a pet is identified based on sensing data obtained through at least one from among the robot 100 and the accessory device 30, the robot 100 may determine at least one from among the luring time, the luring position, or the luring method of the pet based on current cleaning state information and the search information of the pet. For example, the current state information may include at least one from among a space in which cleaning is ended and a cleaning route thereafter. For example, the pet search information may include at least one from among a position of a pet, a current behavior, or a schedule of the pet (e.g., feeding time, snack time, exercise time). For example, the robot 100 may determine at least one from among the luring time, the luring position, or the luring method of the pet based on the space in which cleaning is ended, the cleaning route thereafter, current time, and the pet search information.

FIG. 10 is a diagram illustrating an example in which the accessory device 30 is implemented as the projector robot.

The robot 100 according to an example may transmit a request signal of “lure cat with an image of a butterfly flying about to coordinates (20, 30 position toward a veranda in the living room) after two minutes” to the projector robot 30. For example, the projector robot 30 may move to the living room as shown in FIG. 9 and lure the cat 10 by projecting the image of the butterfly flying about to the wall after two minutes from when the request signal is received. Accordingly, the robot 100 may clean the position where the cat is present without interference.

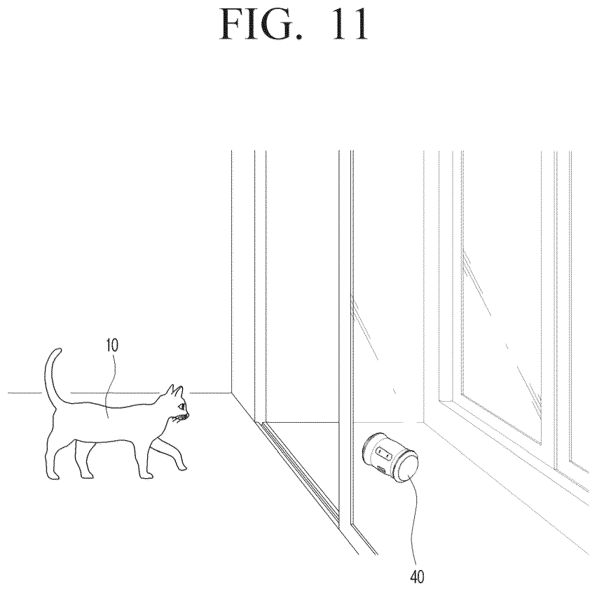

FIG. 11 is a diagram illustrating an example of an accessory device 40 according to an embodiment is implemented as the pet care robot.

According to an example, the robot 100 may transmit a request signal of “lure cat to the living room veranda” to the accessory device 40 which is the pet care robot 40. For example, the pet care robot 40 may lure the cat 10 using various functions after moving to the living room veranda. For example, the pet care robot 40 may lure the cat 10 through at least one from among luring play using a laser pointer, a music play, or outputting a voice of the owner.

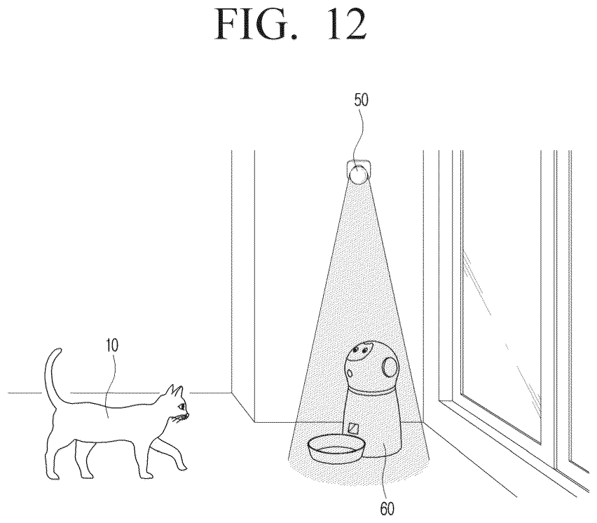

FIG. 12 is a diagram illustrating an example of first and second accessory devices 50 and 60 being implemented as a mood light and a snack dispenser according to an embodiment.

According to an embodiment, if a mood light 50 and a food dispenser 60 are devices with which a pet search is difficult, only the robot 100 may search for pets. For example, the robot 100 may lure, if a pet is detected in a field of vision of the robot cleaner while moving to a master bedroom after cleaning of the living room is ended, the pet to the living room using the mood light 50 and the food dispenser 60 positioned in the living room. For example, the robot 100 may light the mood light 50, and control the food dispenser 60 to provide snacks. For example, the food dispenser 60 may distribute snacks while outputting music that the cat 10 likes.

According to the one or more embodiments described above, limitations occurring in the cleaning route may be prevented by luring the pet to a location that does not interfere with a service (e.g., cleaning) of the robot 100.

The methods according to the one or more embodiments of the disclosure described above may be implemented in an application form installable in a robot of the related art. Alternatively, methods according to the one or more embodiments of the disclosure described above may be performed using a deep learning-based artificial neural network (or deep artificial neural network), that is, a learning network model.

The methods according to the one or more embodiments of the disclosure described above may be implemented with only a software upgrade, or a hardware upgrade for the robot of the related art.

The one or more embodiments of the disclosure described above may be performed through an embedded server provided in the robot, or through an external server of the robot.

According to an embodiment of the disclosure, the one or more embodiments described above may be implemented with software including instructions stored in a machine-readable storage media (e.g., computer). The machine may call a stored instruction from a storage medium, and as a device operable according to the called instruction, may include a robot (e.g., robot (A)) according to the above-mentioned embodiments. Based on a command being executed by the processor, the processor may directly or using other elements under the control of the processor perform a function corresponding to the command. The command may include a code generated by a compiler or executed by an interpreter. A machine-readable storage medium may be provided in a form of a non-transitory storage medium. Herein, “non-transitory” merely means that the storage medium is tangible and does not include a signal, and the term does not differentiate data being semi-permanently stored or being temporarily stored in the storage medium.

In addition, according to an embodiment of the disclosure, a method according to the one or more embodiments described above may be provided included a computer program product. The computer program product may be exchanged between a seller and a purchaser as a commodity. The computer program product may be distributed in a form of the machine-readable storage medium (e.g., a compact disc read only memory (CD-ROM)), or distributed online through an application store (e.g., PLAYSTORE™). In the case of online distribution, at least a portion of the computer program product may be stored at least temporarily in the machine-readable storage medium such as a server of a manufacturer, a server of an application store, or a memory of a relay server, or temporarily generated.

In addition, each of the elements (e.g., a module or a program) according to the one or more embodiments described above may be configured as a single entity or a plurality of entities, and a portion of sub-elements of the above-mentioned sub-elements may be omitted, or other sub-elements may be further included in the one or more embodiments. Alternatively or additionally, a portion of the elements (e.g., modules or programs) may be integrated into one entity to perform the same or similar functions performed by the respective relevant elements prior to integration. Operations performed by a module, a program, or another element, in accordance with one or more embodiments, may be executed sequentially, in a parallel, repetitively, or in a heuristic manner, or at least a portion of the operations may be executed in a different order, omitted or a different operation may be added.

While the disclosure has been illustrated and described with reference to various example embodiments thereof, it will be understood that the various example embodiments are intended to be illustrative, not limiting. It will be understood by those skilled in the art that various changes in form and details may be made therein without departing from the true spirit and full scope of the disclosure, including the appended claims and their equivalents.

What is claimed is:

1. A robot comprising:
communication circuitry;
a driver;
memory storing instructions; and
at least one processor comprising processing circuitry,
wherein the instructions, when executed by the at least one processor individually or collectively, cause the robot to:
based on cleaning being started, transmit, to at least one accessory device through the communication circuitry, a first signal notifying of a start of cleaning and requesting a pet search,
based on receiving search information regarding a pet obtained from the at least one accessory device, transmit, to the at least one accessory device through the communication circuitry, a second signal notifying of a luring position of the pet based on a cleaning position and the search information, and
based on receiving a third signal indicating the pet was successfully lured to the luring position, control the driver to move the robot to the cleaning position and control the robot to start cleaning at the cleaning position.

2. The robot of claim 1, wherein the instructions, when executed by the at least one processor individually or collectively, further cause the robot to:
identify a first cleaning position, from among a plurality of cleaning positions, based on the search information, and
wherein the cleaning position is the first cleaning position.

3. The robot of claim 1, wherein the instructions, when executed by the at least one processor individually or collectively, further cause the robot to:
identify a second cleaning position, from among a plurality of cleaning positions, based on a cleaning route, and
wherein the cleaning position is the second cleaning position.

4. The robot of claim 1, wherein the instructions, when executed by the at least one processor individually or collectively, further cause the robot to:
identify the luring position based on a cleaning route, a position to be cleaned, a position that has been cleaned, and the search information.

5. The robot of claim 1, wherein the instructions, when executed by the at least one processor individually or collectively, further cause the robot to:
identify a luring time based on a cleaning route, an estimated cleaning time, and the search information, and
wherein the second signal further notifies of the luring time.

6. The robot of claim 1, wherein the instructions, when executed by the at least one processor individually or collectively, further cause the robot to:
identify a luring method based on a type of the at least one accessory device and the search information, and
wherein the second signal further notifies of the luring method.

7. The robot of claim 1, wherein the search information comprises at least one from among position information of the pet, movement information of the pet, behavior information of the pet, or profile information of the pet, and
wherein the profile information of the pet comprises at least one from among a type of the pet, a sex of the pet, an age of the pet, or a nature of the pet.

8. The robot of claim 1, wherein the instructions, when executed by the at least one processor individually or collectively, further cause the robot to:
change a cleaning route of the robot based on the search information,
identify a next cleaning position based on the changed cleaning route, and
identify the luring position of the pet based on updated search information corresponding to the next cleaning position.

9. The robot of claim 1, wherein the first signal and the second signal are transmitted to a server through the communication circuitry,
wherein the third signal is received by the robot from the server, and
wherein the server is configured to manage and control a device within a home.

10. The robot of claim 1, wherein the at least one accessory device comprises at least one from among a projector robot, a mood light, a food dispenser, or a pet care robot.

11. A cleaning system comprising:
a robot comprising:
communication circuity;
a driver;
memory storing instructions; and
at least one processor comprising processing circuitry, wherein the at least one processor is configured to individually or collectively execute the instructions; and
an accessory device comprising:
a sensor;
accessory communication circuitry;
accessory memory storing accessory instructions; and
at least one accessory processor comprising accessory processing circuitry, wherein the at least one accessory processor is configured to individually or collectively execute the accessory instructions,
wherein the instructions, when executed by the at least one processor individually or collectively, cause the robot to:
based on cleaning being started, transmit, to the accessory device through the communication circuitry, a first signal notifying of a start of cleaning and requesting a pet search,
wherein the accessory instructions, when executed by the at least one accessory processor individually or collectively, cause the accessory device to:
based on receiving the first signal from the robot, obtain search information regarding a pet based on data obtained through the sensor, and
transmit, to the robot through the accessory communication circuitry, the search information,
wherein the instructions, when executed by the at least one processor individually or collectively, further cause the robot to:
based on receiving the search information from the accessory device, transmit, to the accessory device through the communication circuitry, a second signal notifying of a luring position of the pet based on a cleaning position and the search information,
wherein the accessory instructions, when executed by the at least one accessory processor individually or collectively, further cause the accessory device to:
based on receiving the second signal from the robot, identify a luring method for luring the pet to the luring position, and
based on luring the pet to the luring position, transmit a third signal to the robot through the accessory communication circuitry, and
wherein the instructions, when executed by the at least one processor individually or collectively, further cause the robot to:
based on receiving the third signal indicating the pet was successfully lured to the luring position, control the driver to move the robot to the cleaning position and control the robot to start cleaning at the cleaning position.

12. The cleaning system of claim 11, wherein the instructions, when executed by the at least one processor individually or collectively, further cause the robot to:
identify a first cleaning position, from among a plurality of cleaning positions, based on the search information, and
wherein the cleaning position is the first cleaning position.

13. The cleaning system of claim 11, wherein the instructions, when executed by the at least one processor individually or collectively, further cause the robot to:
identify a second cleaning position, from among a plurality of cleaning positions, based on a cleaning route, and
wherein the cleaning position is the second cleaning position.

14. The cleaning system of claim 11, wherein the instructions, when executed by the at least one processor individually or collectively, further cause the robot to:
identify the luring position based on a cleaning route, a position to be cleaned, a position that has been cleaned, and the search information.

15. The cleaning system of claim 11, wherein the accessory device comprises at least one from among a projector robot, a mood light, a food dispenser, or a pet care robot.

16. A method of controlling a robot, the method comprising:
based on cleaning being started, transmitting, to at least one accessory device, a first signal notifying of a start of cleaning and requesting a pet search;
based on receiving search information regarding a pet obtained from the at least one accessory device, transmitting, to the at least one accessory device, a second signal notifying of a luring position of the pet based on a cleaning position and the search information; and
based on receiving a third signal indicating the pet was successfully lured to the luring position, controlling the robot to move to the cleaning position and start cleaning at the cleaning position.

17. The method of claim 16, further comprising:
identifying a first cleaning position, from among a plurality of cleaning positions, based on the search information,
wherein the transmitting the second signal comprises transmitting, to the at least one accessory device, the second signal notifying of the luring position of the pet based on the first cleaning position and the search information.

18. The method of claim 16, further comprising:
identifying a second cleaning position from among a plurality of cleaning positions based on a cleaning route,
wherein the transmitting the second signal comprises transmitting, to the at least one accessory device, the second signal notifying of the luring position of the pet based on the second cleaning position.

19. The method of claim 16, further comprising:
identifying the luring position based on a cleaning route, a position to be cleaned, a position that has been cleaned, and the search information.

20. The method of claim 16, further comprising:
identifying a luring time based on a cleaning route, an estimated cleaning time, and the search information,
wherein the transmitting the second signal comprises transmitting, to the at least one accessory device, the second signal notifying of the luring position and the luring time.
